(19) United States
(12) Patent Application Publication
(10) Pub. No.: US 2018/0351185 A1
(43) Pub. Date: Dec. 6, 2018

(54) METHOD OF CONTROLLING OPERATION OF FUEL CELL

(71) Applicants: HYUNDAI MOTOR COMPANY, Seoul (KR); KIA MOTORS CORPORATION, Seoul (KR)

(72) Inventors: Ju Han KIM, Yongin-si (KR); Sang Bok WON, Seoul (KR); Kwi Seong JEONG, Yongin-si (KR)

(21) Appl. No.: 15/804,320

(22) Filed: Nov. 6, 2017

(30) Foreign Application Priority Data
May 30, 2017 (KR) 10-2017-0066588

(51) Int. Cl. H01M 8/04537; H01M 8/04302; H01M 8/04858; H01M 8/04955

(52) U.S. Cl. CPC H01M 8/04559; H01M 8/04302; H01M 2250/20; H01M 8/04955; H01M 8/04634; H01M 8/0491

(57) ABSTRACT

Disclosed is a method of controlling operation of a fuel cell system comprising a fuel cell stack provided with a reversal tolerance anode (RTA), in which a reaction state in the fuel cell stack is diagnosed based on cell voltage behavior of the fuel cell stack, and operation according to the diagnosed reaction state is executed upon a cold start of the fuel cell stack, so as to prevent damage to the fuel cell stack and degradation of performance of the fuel cell stack.

### CROSS-REFERENCE TO RELATED APPLICATION

This application is based on and claims under 35 U.S.C. § 119(a) the benefit of priority to Korean Patent Application No. 10-2017-0066588 filed on May 30, 2017 with the Korean Intellectual Property Office, the entire contents of which are incorporated herein by reference.

### TECHNICAL FIELD

The present disclosure relates to a method of controlling operation of a fuel cell. More particularly, it relates to a method of controlling operation of a fuel cell in an electric vehicle under a cold start condition.

### BACKGROUND

A fuel cell, a kind of generator which generates electric energy from other types of energy (e.g., mechanical energy), converts chemical energy into electrical energy by electrochemical reactions in a fuel cell stack, not by combustion as a combustion engine does.

Such a fuel cell is used for supplying electric power to industries and residential houses or for being electric power sources for driving vehicles, and is also used to supply electric power to small electrical/electronic products, particularly, portable devices.

As electric power sources for driving vehicles, among various types of fuel cells, a polymer electrolyte membrane fuel cell (PEMFC) known as a proton exchange membrane fuel cell is used now.

The polymer electrolyte membrane fuel cell has characteristics, such as low operation temperature, high efficiency, high current density and power density, short start-up time, and rapid response to load change, as compared with other types of fuel cells, and may thus be used as a power source for vehicles or portable devices which demand such characteristics of the power source.

The polymer electrolyte membrane fuel cell includes: a membrane electrode assembly (MEA) including a polymer electrolyte membrane, through which hydrogen ions move, and catalyst electrode layers, in which electrochemical reactions occur in both sides of the polymer electrolyte membrane; a gas diffusion layer (GDL) serving to uniformly distribute reaction gases and transmit generated electrical energy; gaskets and fasteners to maintain air tightness and proper tightening pressure of the reaction gases and cooling water; and a bipolar plate to move the reaction gases and the cooling water.

Further, a fuel cell system applied to a fuel cell electric vehicle includes a fuel cell stack to generate electrical energy through electrochemical reactions of reaction gases (e.g., hydrogen serving as fuel and oxygen serving as an oxidizer), a hydrogen supply device to supply hydrogen to the fuel cell stack, an air supply device to supply air including oxygen to the fuel cell stack, a thermal management system to control an operation temperature of the fuel cell system and to execute a water management function, and a fuel cell controller to control overall operation of the fuel cell system.

In a general fuel cell system, the hydrogen supply device includes a hydrogen storage (a hydrogen tank), a regulator, a hydrogen pressure control valve, a hydrogen recirculation device, etc., the air supply device includes an air blower, a humidifier, etc., and the thermal management system includes a cooling water pump, a water tank, a radiator, etc.

A fuel cell exhibits optimal performance at a specific cell temperature range and a specific supplied gas relative humidity range. A PEMFC is operable at a temperature range of about 0° C. to 80° C., but has limited output performance at or below a certain operating temperature.

Particularly, in a cold start condition under which a fuel cell electric vehicle has been turned off and then starting of the fuel cell electric vehicle is carried out at an extremely low temperature, sufficient output performance is not assured and performance of the fuel cell system degrades.

For example, when hydrogen supply to an anode is not sufficient under a condition that load is applied to the fuel cell, an electric potential of the anode may be raised. That is, force to be oxidized is increased. Here, the overall cell voltage (the electric potential of the cathode—the electrical potential of the anode) has a negative value and is thus referred to as a reverse voltage. In this case, at the anode, carbon included in an electrode layer reacts with water and is thus oxidized.

When carbon oxidation is carried out, the anode and a catalyst are greatly damaged and the overall performance of the fuel cell is lowered. Therefore, in order to solve generation of a reverse voltage due to hydrogen starvation, a fuel cell stack having a reversal tolerance anode (RTA) has been developed.

For example, U.S. Pat. No. 6,936,370 discloses a solid polymer fuel cell with improved voltage reversal tolerance in which an oxygen evolution catalyst (OEC), i.e., a water electrolysis catalyst), is added to a conventional anode catalyst in charge of hydrogen oxidation in order to prevent carbon corrosion of an anode and to protect the anode when reverse voltage occurs.

However, when implementing a fuel cell system including the anode components disclosed in the above Patent Document, in order to improve cold start performance and to enhance stack durability, technologies of diagnosing a current reaction state of a stack and executing proper operation control according to the diagnosed current reaction state are required.

### SUMMARY

The present disclosure has been made in an effort to solve the above-described problems associated with the prior art and it is an object of the present disclosure to provide a method of controlling operation of a fuel cell electric vehicle, in which a reaction state in a fuel cell stack is diagnosed based on cell voltage behavior of the fuel cell stack and operation corresponding to a diagnosis state is executed upon cold start of the fuel cell stack, to which a reversal tolerance anode (RTA) is applied, so as to prevent damage to and degradation of the stack.

In one aspect, a method of controlling operation of a fuel cell system comprising a fuel cell stack provided with a reversal tolerance anode (RTA) may include (a) measuring a cell voltage upon a cold start, (b) judging whether or not the measured cell voltage is a reverse voltage, (c) acquiring information regarding a cell voltage decrement and comparing the acquired cell voltage decrement with a reference value predetermined based on the cell voltage decrement, if the measured cell voltage is the reverse voltage in the step (b), and limiting a current of the fuel cell stack or shutting down the fuel cell system, if the cell voltage decrement is the reference value or more as a comparison result of the step (c).

In a preferred embodiment, the method may further include, prior to the step (a), judging whether or not the cold start is executed according to predetermined cold start conditions.

In another preferred embodiment, the method may further include executing predetermined normal cold start control, if the measured cell voltage is not the reverse voltage in the step (b).

In still another preferred embodiment, the method may further include, determining that a reaction in the fuel cell stack is in a normal reaction state or in a hydrogen pumping state at a cathode if the measured cell voltage is not the reverse voltage in the step (b).

In yet another preferred embodiment, if the cell voltage decrement is less than the reference value as a comparison result of the step (c), predetermined normal cold start control may be executed.

In still yet another preferred embodiment, the method may further include, if the cell voltage decrement is less than the reference value as a comparison result of the step (c), determining that a reaction in the fuel cell stack is in a water splitting state at the anode.

In a further preferred embodiment, the method may further include, if the cell voltage decrement is the reference value or more as a comparison result of the step (c), determining that a reaction in the fuel cell stack is in a carbon corrosion state at the anode.

In another further preferred embodiment, the reference value may be set to a value stored in advance in a controller that is configured to calculate the reference value information according to stack temperature and stack current when the cell voltage is measured, and the reference value, calculated by the controller, is applied in acquiring information regarding the cell voltage decrement and the comparison of the acquired cell voltage decrement with the reference value.

In still another further preferred embodiment, the method may further include steps of measuring high frequency resistance of the fuel cell stack and comparing the measured high frequency resistance with a predetermined cell resistance reference value, if the cell voltage decrement is less than the reference value or more, and limiting the current of the fuel cell stack, if the measured high frequency resistance is the predetermined cell resistance reference value or more.

In yet another further preferred embodiment, the method may further include determining that a reaction of the fuel cell stack is a water splitting state at the anode and executing predetermined normal cold start control, if the measured high frequency resistance is less than the predetermined cell resistance reference value.

In another aspect, the present disclosure provides a method of controlling operation of a fuel cell system comprising a fuel cell stack provided with a reversal tolerance anode (RTA), wherein a decrement of IR corrected cell voltage calculated instead of cell voltage.

Other aspects and preferred embodiments of the invention are discussed infra.

The above and other features of the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1(a) is a graph representing change in cell voltage according to time in a normal fuel cell reaction and in ice blocking at a cathode in a fuel cell stack;

FIG. 1(b) is a graph representing change in cell High Frequency Resistance (HFR) according to time in the normal fuel cell reaction and in ice blocking at the cathode in a fuel cell stack;

FIG. 1(c) is a graph representing change in IR corrected cell voltage according to time in the normal fuel cell reaction and in ice blocking at the cathode in a fuel cell stack;

FIG. 2(a) is a graph representing change in cell voltage according to time in water splitting at an anode and in carbon corrosion at the anode in a fuel cell stack;

FIG. 2(b) is a graph representing change in cell HFR according to time in water splitting at the anode and in carbon corrosion at the anode in a fuel cell stack;

FIG. 2(c) is a graph representing change in IR corrected cell voltage according to time in water splitting at the anode and in carbon corrosion at the anode in a fuel cell stack;

FIG. 3 is a graph representing electric potential differences in the respective reactions occurring in a fuel cell;

FIG. 4 is a flowchart illustrating a method of controlling operation of a fuel cell system in accordance with one embodiment of the present disclosure;

FIG. 5 is a flowchart illustrating a method of controlling operation of a fuel cell system in accordance with another embodiment of the present disclosure;

FIG. 6 is a flowchart illustrating a method of controlling operation of a fuel cell system in accordance with yet another embodiment of the present disclosure; and

FIG. 7 is a graph representing change in anode water splitting reaction cell voltage according to temperature and current of a fuel cell stack.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present disclosure, examples of which are illustrated in the accompanying drawings and described below. While the invention will be described in conjunction with exemplary embodiments, it will be understood that the present description is not intended to limit the invention to the exemplary embodiments. On the contrary, the invention is intended to cover not only the exemplary embodiments, but also various alternatives, modifications, equivalents and other embodiments within the spirit and scope of the invention as defined by the appended claims.

The present disclosure proposes technology in which a reaction in a fuel cell stack is diagnosed and a control strategy according to a kind of reaction is established upon cold start of the fuel cell stack, to which a reversal tolerance anode (RTA) is applied, and the control strategy is applied to control of operation of a fuel cell, so as to prevent damage to and degradation of the stack.

Particularly, the present disclosure is characterized in that parameters relating to internal behavior of a fuel cell stack are extracted and a reaction state of the fuel cell stack is diagnosed based on change in the corresponding parameters. Further, the present disclosure is characterized in that state change in the fuel cell stack is estimated according to the diagnosed reaction state and thus prevents generation of behavior relating to damage to and degradation of the stack and improves stack durability. In this case, driving restrictions, such as current limitation, shut down of the stack, etc., are minimized and thus sufficient cold start performance is acquired within a range assuring vehicle stability.

In the present disclosure, a fuel cell stack, to which an RTA is applied, is used so as to prevent increase in reverse voltage by inducing water splitting using water at an anode, upon cold start, and, particularly, if hydrogen supply is insufficient.

Cold start means execution of start of a vehicle at an extremely low temperature at which water in the vehicle may be frozen, and whether or not cold start of the vehicle is executed may be judged according to cold start conditions. In one embodiment of the present disclosure, a series of control is executed on the assumption that a vehicle is in a cold start state, and conventional technology for judging the cold start of vehicle may be used. Accordingly, a detailed description for the techniques for judging the cold start of vehicle will be omitted. For example, the cold start of the vehicle may be judged based on an outdoor temperature of the vehicle.

Further, a reversal tolerance anode (RTA) is an anode in which an oxygen evolution catalyst (water electrolysis catalyst) is added to a conventional anode catalyst so as to assure enough water to satisfy current load during operation of a fuel cell. For example, the RTA is formed by additionally including a catalyst to promote water splitting when reverse voltage occurs, in order to improve stack durability in a reverse voltage occurrence condition of a fuel cell stack. However, in the description of the present disclosure, a stack to which an RTA is applied means a stack configured to induce water splitting so as to reduce occurrence of reverse voltage, and is not limited to a stack having a specific electrode structure.

Hereinafter, a method of controlling operation of a fuel cell system comprising a fuel cell stack in accordance with one embodiment of the present disclosure will be described in detail.

Upon cold start of a fuel cell electric vehicle, different reactions in the fuel cell stack occur according to the inner state of a fuel cell stack. In more detail, a reaction in the fuel cell stack upon cold start is varied according to a supply level of reaction gases, such as hydrogen and air, in catalyst layers. That is, upon cold start, a normal fuel cell reaction occurs when a sufficient amount of hydrogen and a sufficient amount of air are supplied but, if ice is formed at a cathode and thus ice blocking occurs at the cathode, oxygen at a cathode catalyst is insufficient. When oxygen is generated at the cathode, voltage drop or hydrogen pumping occurs.

On the other hand, if ice is formed at an anode and thus ice blocking occurs at the anode, hydrogen in a catalyst layer is insufficient. Here, when reactive water is present at the anode, water splitting at the anode occurs. Therefore, when an RTA catalyst is applied, such water splitting may be induced and, thus damage to the anode catalyst will be prevented or decreased.

On the other hand, upon cold start, under the condition that ice blocking occurs and hydrogen in the catalyst layer is insufficient, reactive water is consumed or is frozen into ice and it may be difficult to execute water splitting. That is, under such a condition, water for water splitting is not present and, thus, carbon corrosion of the anode catalyst occurs. Therefore, a hot spot is generated due to rapid damage to the anode catalyst and increase in heating value and, finally, a bipolar plate may be damaged.

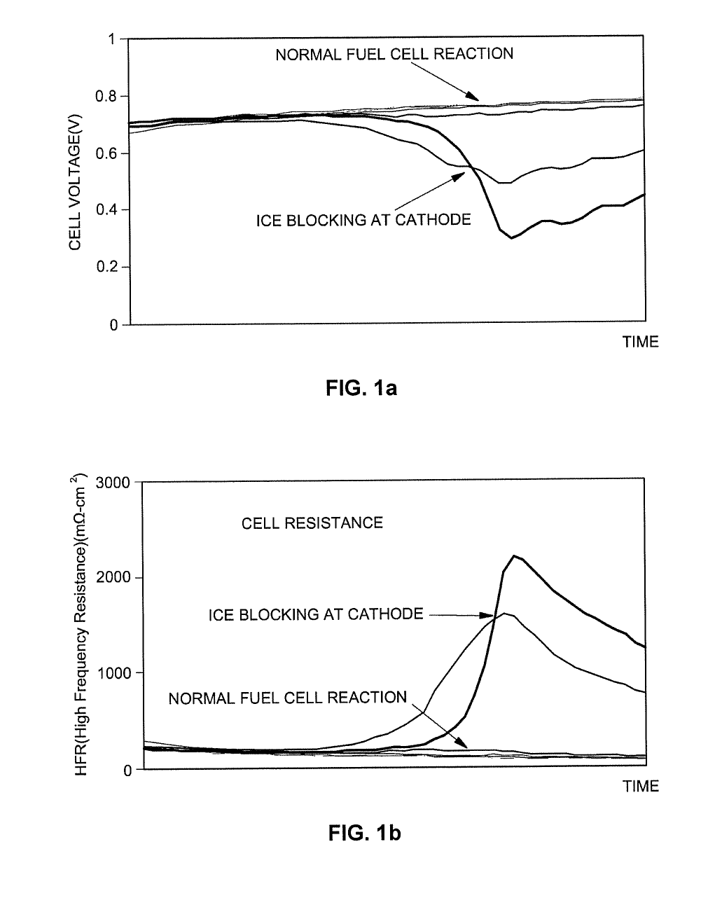

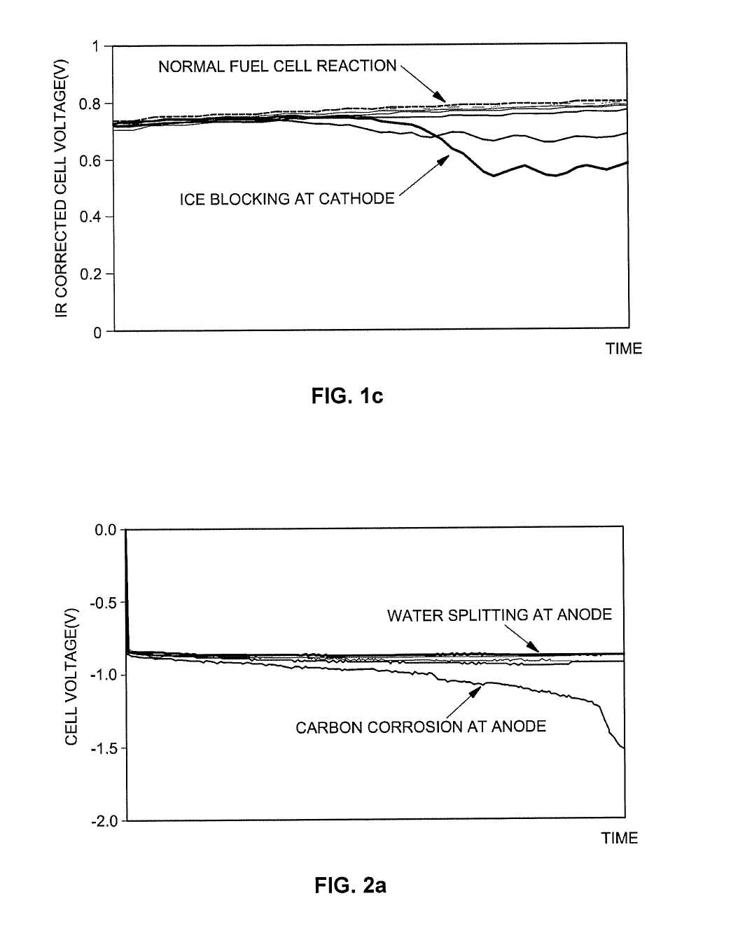

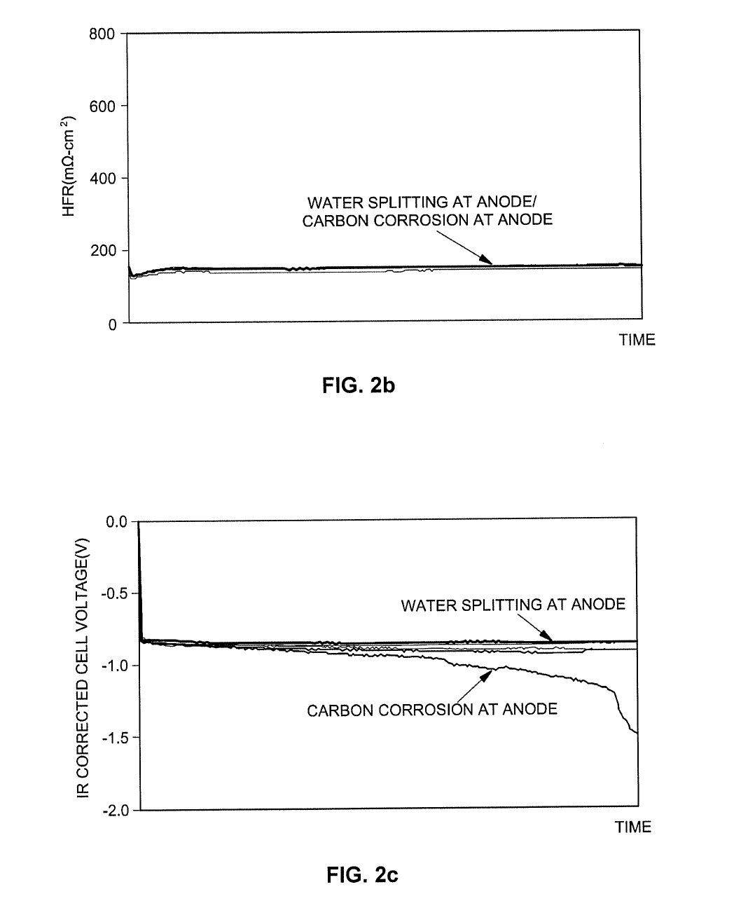

FIGS. 1(a) to 2(c) are graphs representing changes in cell internal behavior according to time, when constant current is maintained upon cold start.

Particularly, FIGS. 1(a) to 1(c) are graphs representing changes in a normal fuel cell reaction and in ice blocking at a cathode in a fuel cell stack, and, more particularly, FIG. 1(a) is a graph representing change in cell voltage according to time, FIG. 1(b) is a graph representing change in cell HFR according to time, and FIG. 1(c) is a graph representing change in IR corrected cell voltage according to time.

Further, FIGS. 2(a) to 2(c) are graphs representing changes in water splitting at an anode and in carbon corrosion at the anode in the fuel cell stack, and, more particularly, FIG. 2(a) is a graph representing change in cell voltage according to time, FIG. 2(b) is a graph representing change in cell HFR according to time, and FIG. 2(c) is a graph representing change in IR corrected cell voltage according to time.

Now, respective reaction states will be described. If sufficient amounts of oxygen and air are supplied, a normal fuel cell reaction occurs. As exemplarily shown in FIG. 1(a), in the normal fuel cell reaction, when constant current is maintained, cell voltage according to current is constantly maintained within a range of 0.6 to 1.0 V. A normal fuel cell reaction equation in will be described below.

Anode:2H₂→4H⁺+4e⁻

Cathode:4H⁺+O₂+4e⁻→2H₂O

Overall:2H₂+O₂→2H₂O

On the other hand, when ice blocking at the cathode occurs upon cold start, voltage drop of hydrogen pumping occurs due to oxygen starvation at a cathode catalyst. A hydrogen pumping reaction equation will be described below.

Anode:2H₂→4H⁺+4e⁻

Cathode:4H⁺4e⁻→2H₂

Overall:2H₂→2H₂

Change in cell resistance may be observed from change in high frequency resistance, i.e., stack resistance at a high frequency. Change in high frequency may be acquired from a result of calculation of resistance, obtained by applying current of 1 kHz or more to the fuel cell and measuring change in voltage according to applied current.

In operation of the fuel cell electric vehicle at temperatures below zero at constant current, the cell HFR is minutely lowered according to increase in hydration of electrolyte membrane. However, as time goes by, ice is formed in a gas diffusion layer and catalyst layers and, thus, the cell HFR is gradually increased, as exemplarily shown in FIG. 1(a), and cell voltage is decreased, as exemplarily shown in FIG. 1(a).

Here, cell voltage drop due to concentration loss and HFR are increased and, thus, IR corrected cell voltage is decreased, as exemplarily shown in FIG. 1(c). Here, IR corrected cell voltage is determined below.

IR corrected cell voltage=cell voltage+IR voltage drop=cell voltage+high frequency resistance*current

Thereafter, if, as time passes, cell internal temperature is raised, ice at the cathode is melted and, thus, increased high frequency resistance is decreased again and cell voltage is increased again.

On the other hand, if hydrogen in the catalyst layer is insufficient and reactive water is present at the anode, water splitting at the anode occurs. In this case, as stated in a reaction equation below, water splitting at the anode occurs using water at the anode.

Anode:2H₂O→O₂+4H⁺+4e⁻

Cathode:4H⁺+O₂+4e⁻→2H₂O

Overall:2H₂O+O₂→O₂+2H₂O

Therefore, when water splitting occurs due to sufficient water at the anode, cell voltage is constantly maintained at a level of about −1V or is minutely dropped if constant current is maintained (with reference to FIG. 2(a)). On the other hand, as exemplarily shown in FIG. 2(b), when water splitting occurs at the anode, the cell HFR is constantly maintained. Therefore, when water splitting occurs at the anode, IR corrected cell voltage is also maintained at a constant level (with reference to FIG. 2(c)).

On the other hand, if hydrogen in the catalyst layer is insufficient and reactive water is consumed already or is frozen into ice, water splitting does not occur. In this case, as stated in a reaction equation below, carbon corrosion of the anode catalyst occurs due to oxidation of carbon in the catalyst layer.

Anode:C+2H₂O→CO₂+4H⁺+4e⁻

Cathode:4H⁺+O₂+4e⁻→2H₂O

Overall:C+2H₂O+O₂→2H₂O+CO₂

When the anode catalyst is damaged due to carbon oxidation, an anode reaction area is decreased and, thus, when constant current is maintained, cell voltage is consistently dropped, as exemplarily shown in FIG. 2(a). On the other hand, even in the carbon corrosion state at the anode, the cell HFR is constantly maintained, as exemplarily shown in FIG. 2(b). Therefore, IR corrected cell voltage is also consistently dropped, as exemplarily shown in FIG. 2(c).

Particularly, the predominant reason for cell voltage drop is that the anode catalyst is damaged due to carbon corrosion of the anode catalyst and the anode reaction area is decreased thereby.

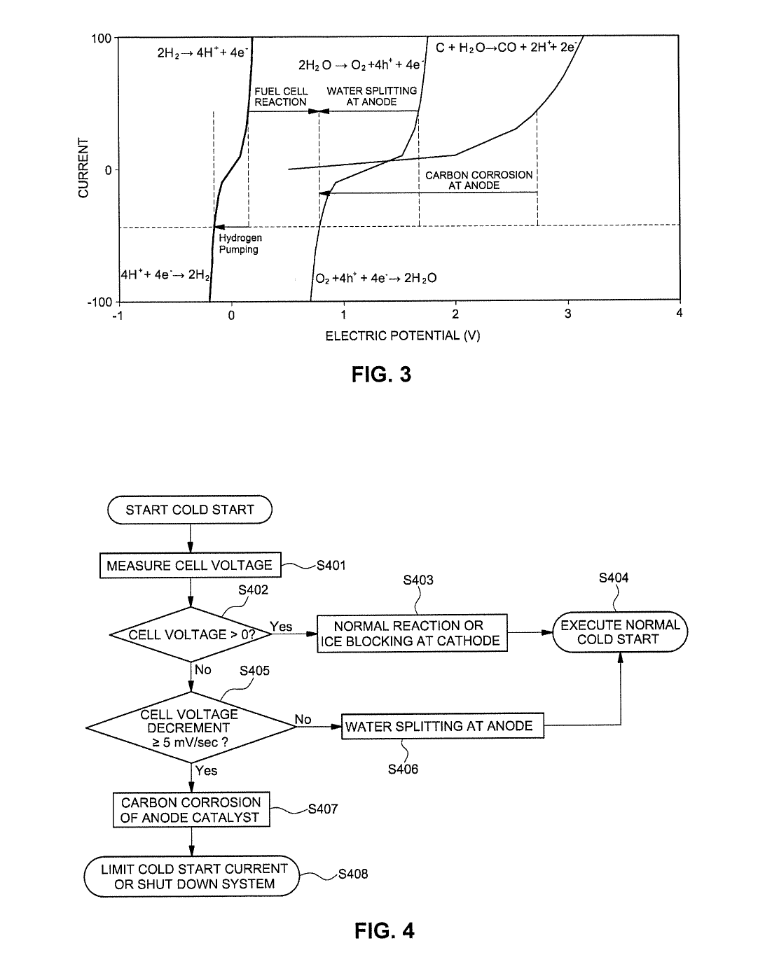

FIG. 3 is a graph representing electric potential differences in the respective reactions occurring in the fuel cell. That is, FIG. 3 represents reaction states at the anode or the cathode and electric potential differences in the corresponding reaction states. In more detail, as exemplarily shown in FIG. 3, it may be confirmed that cell voltage has a negative value (−) and is thus in a reverse voltage state in water splitting at the anode and in carbon corrosion at the anode and, particularly, reverse voltage is increased in carbon corrosion at the anode. The reverse voltage state in water splitting at the anode and in carbon corrosion at the anode may also be confirmed from FIG. 2(a).

This embodiment is characterized in that, among the above-described reaction states, the carbon corrosion state at the anode, in which damage to the anode catalyst is expected, is regarded as a dangerous state and corresponding control, such as current limitation or system shutdown, is executed even in respect to the corresponding reaction state.

That is, as stated Table 1 below, even if reverse voltage occurs in water splitting at the anode, it is judged that cell damage is not expected and, thus, a normal cold start procedure is executed.

TABLE 1

| | Cell | | |
|---|---|---|---|
| Cell | voltage | | |
| voltage | decrement | Diagnosis | Control strategy |
| (+) | Small | Normal | Execution of normal cold start |
| (+) | Large | Hydrogen pumping | Execution of normal cold start |
| | | at cathode | |
| (−) | Small | Water splitting | Execution of normal cold start |
| | | at anode | |
| (−) | Large | Carbon corrosion | Current limitation/system |
| | | of anode catalyst | shutdown |

Here, a cell voltage decrement DV is defined as below.

DV=−dV/dt=−(V(t₂)−V(t₁))/(t₂−t₁)(t₂ and t₁ are time,t₂>t₁)

Here, the cell voltage decrement DV means a cell voltage decreasing amount by designated time intervals, and time interval setting is important. That is, if the time interval is set to be excessively long, cell damage due to cell voltage drop may be caused and, if the time interval is set to be excessively short, reaction discrimination to diagnose reactions may be lowered. Therefore, the cell voltage decrement DV may be set to have a value which may cause small cell damage and be a level sufficient to discriminate reaction states.

One embodiment of the present disclosure is characterized in that information regarding cell voltage and a cell voltage decrement is acquired and reaction state diagnosis and control corresponding to the diagnosis are executed thereby. FIG. 4 is a flowchart illustrating a method of controlling operation of a fuel cell system comprising a fuel cell stack in accordance with this embodiment of the present disclosure. Although not shown in FIG. 4, in order to confirm a cold start state, judgment as to whether or not cold start is executed according to cold start conditions may be additionally carried out.

As exemplarily shown in FIG. 4, when cold start of a fuel cell electric vehicle is started, cell voltage is measured (Operation S401). Whether or not the measured cell voltage is forward voltage (+) or reverse voltage (−) is judged (Operation S402) and, upon judging that the cell voltage is forward voltage, i.e., if the cell voltage is greater than 0, it is judged that the fuel cell is in a normal reaction state or a hydrogen pumping state due to ice blocking at a cathode (Operation S403). Therefore, upon judging that the fuel cell is in the normal reaction state or the hydrogen pumping state at the cathode, it is judged that there is no possibility of cell damage and, thus, normal cold start is executed (Operation S404).

On the other hand, upon judging that the cell voltage is reverse voltage, i.e., if the cell voltage is 0 or less, information regarding a cell voltage decrement is acquired and is then compared with a first reference value (Operation S405). Here, the first reference value is an intrinsic value set according to the fuel cell and may thus be set as a value input in advance to a controller to control cold start. For example, the first reference value may be set to 5 mV/sec and this means that the cell voltage is decreased by 5 mV per second. The first reference value may be set to a value predetermined according to cell voltage change data collected in advance, as exemplarily shown in FIG. 2(a). For example, the first reference value for discriminating water splitting at the anode and carbon corrosion of the anode catalyst from each other may be set from a gradient of a curve regarding carbon corrosion of the anode catalyst in FIG. 2(a).

The controller, coupled to the fuel cell system, is an electric circuitry that executes instructions of software which thereby performs various functions described hereinafter.

As exemplarily shown in FIG. 4, if the cell voltage is reverse voltage and the cell voltage decrement is the first reference value or more, i.e., if the cell voltage is greatly decreased, it is judged that the fuel cell is in a carbon corrosion state of the anode catalyst (Operation S407). On the other hand, if the cell voltage is reverse voltage and the cell voltage decrement is less than the first reference value, if decrease in the cell voltage is not great, it is judged that the fuel cell is in a water splitting state at the anode (Operation S406). Therefore, if the cell voltage decrement is less than the first reference value, normal cold start is executed but, if the cell voltage decrement is the first reference value or more, in order to prevent cell damage, the stack current is limited during the cold start or the fuel cell system is shutdown (Operation S408).

Judgment as to the respective reaction states in Operations S403, S406 and S407 may be omitted and, without such judgment as to the respective reaction states, normal cold start may be executed (Operation S404) or control for cold start current limitation or shutdown of the fuel cell system may be executed (Operation S408) according to a result of judgment as to the respective conditions (Operations S402 and S405).

Table 2 below states diagnoses and control strategies regarding a method of controlling operation a fuel cell in accordance with another embodiment of the present disclosure.

TABLE 2

| IR corrected | IR corrected cell | | |
|---|---|---|---|
| cell voltage | voltage decrement | Diagnosis | Control strategy |
| (+) | Small | Normal | Execution of normal cold start |
| (+) | Large | Hydrogen pumping at cathode | Execution of normal cold start |
| (−) | Small | Water splitting at anode | Execution of normal cold start |
| (−) | Large | Carbon corrosion of anode | Current limitation/system |
| | | catalyst | shutdown |

That is, as confirmed from Table 2 above, this embodiment of the present disclosure is substantially the same as the former embodiment of the present disclosure stated in Table 1 except that IR corrected cell voltage and an IR corrected cell voltage decrement are used instead of the cell voltage and the cell voltage decrement in Table 1.

Here, an IR corrected cell voltage decrement DV_IRC is defined as below.

DV_IRC=−dV_IRC/dt=−(V_IRC(t₂)−V_IRC(t₁))/(t₂−t₁)

Here, V_IRC indicates IR corrected cell voltage, and t₂ and t₁ are time (t₂>t₁).

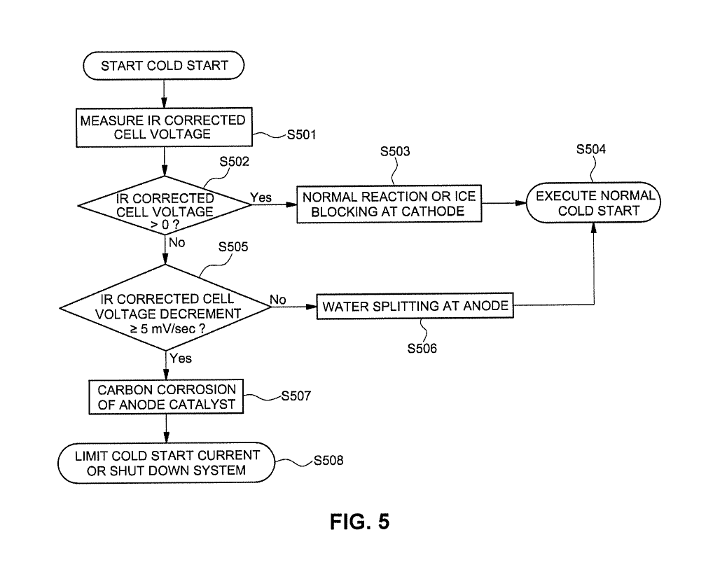

FIG. 5 is a flowchart illustrating a method of controlling operation of a fuel cell system in accordance with this embodiment of the present disclosure. As exemplarily shown in FIG. 5, when cold start of a fuel cell electric vehicle is started, IR corrected cell voltage is measured (Operation S501). Whether or not the measured IR corrected cell voltage is forward voltage (+) or reverse voltage (−) is judged (Operation S502) and, upon judging that the IR corrected cell voltage is forward voltage, i.e., if the IR corrected cell voltage is greater than 0, it is judged that the fuel cell is in a normal reaction state or a hydrogen pumping state due to ice blocking at a cathode (Operation S503). Therefore, upon judging that the fuel cell is in the normal reaction state or the hydrogen pumping state at the cathode, it is judged that there is no possibility of cell damage and, thus, normal cold start is executed (Operation S504).

On the other hand, upon judging that the IR corrected cell voltage is reverse voltage, i.e., if the IR corrected cell voltage is 0 or less, information regarding an IR corrected cell voltage decrement is acquired and is then compared with a second reference value (Operation S505). Here, the second reference value is an intrinsic value set according to the fuel cell stack and may thus be set as a value input in advance to a controller to control cold start, and the second reference value may be determined in consideration of a gradient of a curve in FIG. 2(c). The second reference value may be set to 5 mV/sec in the same manner as the first reference value.

If the IR corrected cell voltage is reverse voltage and the IR corrected cell voltage decrement is the second reference value or more, i.e., if the IR corrected cell voltage is greatly decreased, it is judged that the fuel cell is in a carbon corrosion state of the anode catalyst (Operation S507). On the other hand, if the IR corrected cell voltage is reverse voltage and the IR corrected cell voltage decrement is less than the second reference value, if decrease in the IR corrected cell voltage is not great, it is judged that the fuel cell is in a water splitting state at the anode (Operation S506). Therefore, if the IR corrected cell voltage decrement is less than the second reference value, normal cold start is executed but, if the IR collected cell voltage decrement is the second reference value or more, in order to prevent cell damage, the stack current is limited during the cold start or the fuel cell system is shutdown (Operation S508).

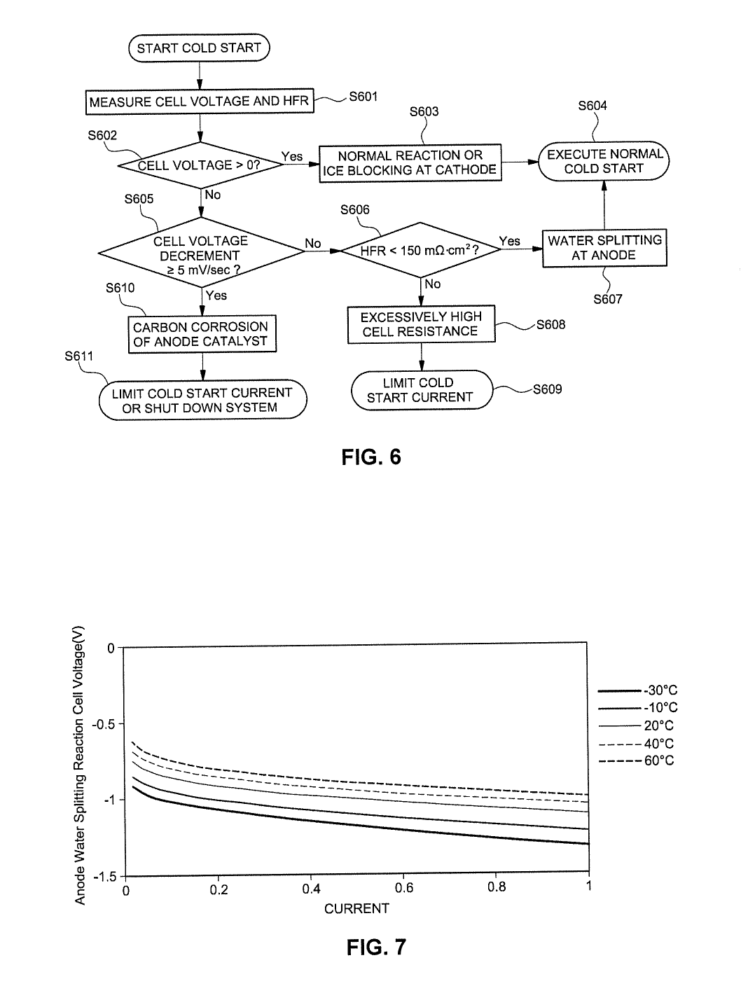

FIG. 6 is a flowchart illustrating a method of controlling operation of a fuel cell system in accordance with yet another embodiment of the present disclosure.

As exemplarily shown in FIG. 6, this embodiment of the present disclosure is characterized in that a fuel cell stack is diagnosed according to cell voltage and a cell voltage decrement and a strategy corresponding thereto is determined, in the same manner as in the former embodiment shown in FIG. 4, and, additionally, high frequency resistance (HFR) is considered.

Particularly, a series of processes of diagnosing the fuel cell stack according to the cell voltage and the cell voltage decrement is substantially the same as in the former embodiment shown in FIG. 4 and a detailed description thereof will thus be omitted. That is, Operations S602 to 605 are the same as Operations S402 to S405 of FIG. 4, and Operations S610 to S611 are the same as Operations S407 and S408. However, the method in accordance with this embodiment of the present disclosure further includes measuring high frequency resistance of the fuel cell stack together with cell voltage in Operation S601, comparing the measured high frequency resistance to predetermined reference resistance (Operation S606) and limiting cold start current according to a result of comparison (Operation S609). That is, as exemplarily shown in FIG. 6, as a result of comparison between the measured high frequency resistance and a third reference value, upon judging that the high frequency resistance is the third reference value or more, i.e., upon judging that cell resistance is excessively high, it is judged that heating is excessive and, thus, the method further includes limiting cold start current (Operations S608 and S609). On the other hand, upon judging that the high frequency resistance is less than the third reference value, it is judged that the fuel cell is in a water splitting state at the anode (Operation S607) and then normal cold start is executed (Operation S604), as exemplarily shown in FIG. 6. The third reference value may be a value selected from a test result in consideration of the heating state of the fuel cell and, particularly, be a 150 mΩ·cm².

FIG. 7 is a graph representing change in anode water splitting reaction cell voltage according to temperature and current of a fuel cell stack.

In the water splitting reaction at the anode, voltage in the water splitting reaction at the anode is lowered when temperature is lowered and voltage in the water splitting reaction at the anode is raised when temperature is raised. Further, voltage in the water splitting reaction at the anode is lowered as current is increased.

Further, when cell voltage is lower than voltage in the water splitting reaction at the anode at the operating temperature of the fuel cell, carbon corrosion at the anode occurs.

Therefore, whether or not carbon corrosion at the anode occurs may be judged by measuring cell voltage, stack current and stack operating temperature and calculating voltage in the water splitting reaction at the anode corresponding to the measured temperature and current. That is, if current stack temperature, current and cell voltage are detected and voltage in the water splitting reaction at the anode is calculated based on the current stack temperature and current, whether or not carbon corrosion at the anode occurs may be judged by comparing the current cell voltage with the calculated voltage in the water splitting reaction at the anode.

For example, a controller to control cold start is configured to store reference value information in advance. Here, the controller may be configured to calculate reference value information according to stack temperature and stack current. In this case, in Operation S405 or S505, a reference value calculated by the controller may be applied according to stack temperature and current condition when cell voltage is measured.

Therefore, if the current cell voltage is higher than voltage in the water splitting reaction at the anode according to the corresponding temperature and current, carbon corrosion at the anode does not occur and, thus, normal cold start is executed. On the other hand, if the current cell voltage is lower than voltage in the water splitting reaction at the anode according to the corresponding temperature and current, it is judged that the fuel cell is in the carbon corrosion state at the anode and, thus, current limitation or system shutdown is executed.

Here, voltage in the water splitting reaction at the anode according to temperature and current may be data stored in advance in the controller, and such data may be calculated in real time according to temperature and current using a predetermined calculation equation.

Therefore, in this embodiment, cold start may be controlled regardless of changes in temperature and current.

As is apparent from the above description, a method for controlling operation of a fuel cell system in accordance with one embodiment of the present disclosure has effects as follows.

First, a reaction state within a fuel cell stack may be correctly diagnosed based on cell voltage behavior of the fuel cell stack upon cold start of a fuel cell electric vehicle having the fuel cell stack.

Second, the fuel cell may correctly cope with the reaction state within the fuel cell stack and, thus, stack damage and degradation may be prevented and stack durability may be improved.

Third, current limitation executed in consideration of electrode damage, etc. upon cold start may be reduced and fuel cell and vehicle stoppage may be prevented, thus enhancing cold start performance and vehicle stability.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method of controlling operation of a fuel cell system comprising a fuel cell stack provided with a reversal tolerance anode (RTA), comprising steps of:
(a) measuring a cell voltage upon a cold start;
(b) judging whether or not the measured cell voltage is a reverse voltage;
(c) acquiring information regarding a cell voltage decrement and comparing the acquired cell voltage decrement with a reference value predetermined based on the cell voltage decrement, if the measured cell voltage is the reverse voltage in the step (b); and
(d) limiting a current of the fuel cell stack or shutting down the fuel cell system, if the cell voltage decrement is the reference value or more as a comparison result in the step (c).

2. The method of claim 1, further comprising, prior to the step (a), judging whether or not the cold start is executed according to predetermined cold start conditions.

3. The method of claim 1, further comprising:
executing predetermined normal cold start control, if the measured cell voltage is not the reverse voltage in the step (b).

4. The method of claim 1, further comprising: determining that a reaction in the fuel cell stack is in a normal reaction state or in a hydrogen pumping state at a cathode, if the measured cell voltage is not the reverse voltage in the step (b).

5. The method of claim 1, wherein, if the cell voltage decrement is less than the reference value as a comparison result in the step (c), predetermined normal cold start control is executed.

6. The method of claim 1, further comprising: if the cell voltage decrement is less than the reference value as a comparison result in the step (c), determining that a reaction in the fuel cell stack is in a water splitting state at the anode.

7. The method of claim 1, further comprising: if the cell voltage decrement is the reference value or more as a comparison result in the step (c), determining that a reaction in the fuel cell stack is in a carbon corrosion state at the anode.

8. The method of claim 1, wherein:
the reference value is set to a value stored in advance in a controller that is configured to calculate the reference value according to stack temperature and stack current when the cell voltage is measured; and
the reference value, calculated by the controller, is applied in acquiring information regarding the cell voltage decrement and the comparison result of the acquired cell voltage decrement with the reference value.

9. The method of claim 1, further comprising steps of:
measuring high frequency resistance of the fuel cell stack and comparing the measured high frequency resistance with a predetermined cell resistance reference value, if the cell voltage decrement is less than the reference value or more; and
limiting the current of the fuel cell stack, if the measured high frequency resistance is the predetermined cell resistance reference value or more.

10. The method of claim 9, further comprising:
determining that a reaction of the fuel cell stack is a water splitting state at the anode and executing predetermined normal cold start control, if the measured high frequency resistance is less than the predetermined cell resistance reference value.

11. A method of controlling operation of a fuel cell system comprising a fuel cell stack provided with a reversal tolerance anode (RTA), comprising steps of:
(a) measuring an IR corrected cell voltage upon a cold start;
(b) judging whether or not the measured IR corrected cell voltage is a reverse voltage;
(c) acquiring information regarding an IR corrected cell voltage decrement and comparing the acquired IR corrected cell voltage decrement with a predetermined reference value, if the measured IR corrected cell voltage is the reverse voltage in the step (b); and
(d) limiting a current of the fuel cell stack or shutting down the fuel cell system, if the IR corrected cell voltage decrement is the reference value or more as a comparison result in the step (c).

12. The method of claim 11, further comprising: prior to the step (a), judging whether or not the cold start is executed according to predetermined cold start conditions.

13. The method of claim 11, further comprising:
executing predetermined normal cold start control if the measured IR corrected cell voltage is not the reverse voltage in the step (b).

14. The method of claim 11, further comprising: determining that a reaction in the fuel cell stack is in a normal reaction state or in a hydrogen pumping state at a cathode, if the measured cell voltage is not the reverse voltage in the step (b).

15. The method of claim 11, wherein, if the IR corrected cell voltage decrement is less than the reference value as a comparison result in the step (c), predetermined normal cold start control is executed.

16. The method of claim 11, further comprising: if the IR corrected cell voltage decrement is less than the reference value as a comparison result in the step (c), determining that a reaction in the fuel cell stack is in a water splitting state at the anode.

17. The method of claim 11, further comprising; if the IR corrected cell voltage decrement is the reference value or more as a comparison result in the step (c), determining that a reaction in the fuel cell stack is in a carbon corrosion state at the anode.

18. The method of claim 11, wherein:
the reference value is set to a value stored in advance in a controller that is configured to calculate the reference value according to stack temperature and stack current when the IR corrected cell voltage is measured; and
the reference value, calculated by the controller, is applied in acquiring information regarding the IR corrected cell voltage decrement and the comparison result of the acquired IR corrected cell voltage decrement with the reference value predetermined based on the cell voltage decrement.

19. The method of claim 11, further comprising:
measuring high frequency resistance of the fuel cell stack and comparing the measured high frequency resistance with a predetermined cell resistance reference value, if the IR corrected cell voltage decrement is less than the reference value or more; and
limiting the current of the fuel cell stack, if the measured high frequency resistance is the predetermined cell resistance reference value or more.

20. The method of claim 19, further comprising determining that a reaction of the fuel cell stack is a water splitting state at the anode and executing predetermined normal cold start control, if the measured high frequency resistance is less than the predetermined cell resistance reference value.
